(19) United States
(12) Patent Application Publication
(10) Pub. No.: US 2001/0029490 A1
(43) Pub. Date: Oct. 11, 2001

(54) Automatic transaction device and recording medium having a transaction program which can be read by a computer

(75) Inventor: Kiyoshi Inamochi, Maebashi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Fujitsu Limited, Kawasaki (JP)

(21) Appl. No.: 09/776,858

(22) Filed: Feb. 6, 2001

(30) Foreign Application Priority Data
Apr. 11, 2000 (JP) 2000-109941

(51) Int. Cl. G06F 17/60; G06K 5/00; G06F 7/08

(52) U.S. Cl. 705/43; 235/380; 235/381; 705/42; 705/39

(57) ABSTRACT

An automatic machine which, upon selection of a normal transaction, executes a normal transaction process with a normal transaction-use host based upon a processing state table (A state, etc.), is provided with a WEB transaction-use processing state table (w state) for stipulating the WEB transaction through the WWW, and a WEB transaction control section which, upon selection of the WEB transaction, executes a WEB transaction process with a predetermined WEB server based upon the WEB transaction-use processing state table. Thus, it is possible to execute not only normal transactions, but also the WEB transaction which deals with new trading while updating information on demand.

### FIELD OF THE INVENTION

The present invention relates to an automatic transaction device (automatic machine), such as an ATM (Automatic Teller Machine) and a CD (Cash Dispenser), in a bank or a credit company, and also to a recording medium which is read by a computer and which records a transaction program for allowing a computer to execute transaction methods such as WEB transaction, cash transaction, remittance, checking of the balance, etc.

### BACKGROUND OF THE INVENTION

In recent years, along with the ever-increasing development and use of the Internet, the WEB transaction using the WWW(World Wide Web) on the Internet has come to be widely utilized. In the WEB transaction, electronic trading such as WEB shopping is carried out through a user's personal computer and various kinds of information and advertisements have been given through the WEB. The WEB page used here is updated on demand. Here, in order to reduce face-to-face transactions, banks and credit companies have been introducing automatic transaction devices (automatic machines) which automatically execute predetermined normal transactions such as cash transaction, remittance, checking of the balance, etc. However, in conventional automatic transaction devices, although they can execute predetermined normal transactions, they fail to execute the WEB transaction which can deal with new trading while updating information on demand, and there have been increasing demands for methods for solving this problem effectively.

In the conventional WEB transaction, first, the URL (User Resource Locator) to be accessed is specified, and an access is made to the URL sight. Then, the user can carry out transactions by inputting the credit card number, etc. through the keyboard and making communications. The records of these transactions are not officially stored. In contrast, in a conventional automatic transaction device, for example, based upon a plurality of transaction processing state tables that are classified into types of respective functions in the automatic transaction device, a transaction control means executes controlling operations of predetermined normal transactions such as cash transaction, remittance, checking of the balance, etc. Each of these processing state tables is constituted by 8 parameters (state parameters), each having 3 bytes, and each transaction processing is defined by these state parameters.

However, in the above-mentioned conventional automatic transaction device, mainly because a processing state for the WEB transaction, which forms a long state including the specification of a URL, is not included in the state parameter of 8×3 bytes of the processing state table, the processing state table for the WEB transaction has not been defined, and no control means is provided for controlling the WEB transaction; consequently, the conventional automatic transaction device has failed to execute the WEB transaction which can deal with new trading while updating information on demand, and can only execute predetermined normal transactions. Moreover, since one transaction control means controls all the transactions, the addition of a new transaction function gives effects on the existing transaction controlling processes, resulting in problems of time-consuming tasks and high costs.

In the conventional WEB transaction, after accessing a URL sight through a personal computer and making a WEB transaction, the user has to input user information such as a credit card number through the keyboard, and the record of the transaction is not officially stored; this results in problems of time-consuming tasks and degradation in reliability of the transaction.

### SUMMARY OF THE INVENTION

It is an object of the present invention to provide an automatic transaction device which can execute not only normal transactions, but also the WEB transaction which deals with new trading while updating information on demand, and also to provide a recording medium which is read by a computer, and records the transaction program.

In order to achieve the above-mentioned objective, the automatic transaction device (automatic machine 101) of the present invention, which carries out a normal transaction process with a predetermined host (normal transaction-use host 102) based upon a processing state table (A state, etc.) when a normal transaction operation is specified, is provided with: a WEB transaction-use processing state table (w state) for stipulating WEB transaction carried out by the WWW; and a WEB transaction processing means (WEB transaction control section 303) for executing a WEB transaction process with a predetermined WEB server (WEB server 103) based upon the WEB transaction-use processing state table when the WEB transaction is selected.

In this case, the automatic transaction device is a so-called automatic machine which executes an automatic transaction with a user (customer) while virtually communicating with the user, such as an ATM (Automatic Teller Machine) and a CD (Cash Dispenser), in banks and credit companies. Moreover, the normal transactions refer to predetermined transactions such as cash transaction, remittance, checking of the balance, etc., which have been carried out by conventional automatic transaction devices. In these normal transactions, the transaction is carried out by making a contact with a normal transaction-use host such as a main frame through a dedicated line or a public line, without using the Internet.

Here, in addition to electronic trading that has been conventionally carried out by personal computers, etc., the WEB transaction includes WEB shopping developed for use in automatic transaction devices, issuance of free movie tickets, publishing and advertisements, etc. In the WEB transaction, the transaction is executing while connecting to a WEB server through the WWW (World Wide Web). Moreover, the WEB transaction processing means is placed in a separated manner from the means for carrying out the normal transactions. For example, this is individually installed by using, for example, object-directive programming, etc.

In accordance with this invention, the WEB transaction processing means (WEB transaction control section 303) controls the WEB transaction based upon at least one WEB transaction-use processing state table (w state) used for the WEB transaction. Thus, it is possible to execute not only normal transactions, but also WEB transactions which can deal with new trading while updating information on demand, without giving adverse effects on the control process for the normal transactions.

Moreover, the present invention relates to a recording medium which has a transaction program for allowing a computer to execute various transaction methods, and is read by a computer, and the recording medium is provided with a transaction program which allows the computer to execute WEB transaction processing operation with the predetermined server (WEB server 103) based upon the WEB transaction-use processing state table (w state) when the WEB transaction is selected.

Here, “the recording medium that is read by a computer” includes “portable physical media” including magnetic disks such as floppy disks, semiconductor memories such as ROMs, EPROMs, EEPROMs and flash ROMs (including those built in cartridges, PC cards, etc.), optical disks such as CD-ROMs and DVDs and magneto-optical disks such as MOs and “fixed physical media” including ROMs, RAMs, hard disks, etc. that are built in various computer systems.

Moreover, “the recording medium that is read by a computer” may also include communication media which temporarily hold programs, such as a communication line used upon transmitting a program through a network such as LAN, WAN and the Internet. Furthermore, “a program” refers to a written form of a data processing method; and it is not intended to be limited by languages and methods in which it is written, and any format, such as source code, binary code and execution format, may be adopted. Additionally, “the program” is not limited to those singly formed, and may include those constituted in a dispersed manner as a plurality of modules and libraries and those which can achieve their function in cooperation with another program such as an OS.

Other objects and features of this invention will become understood from the following description with reference to the accompanying drawings.

### BRIEF DESCRIPTION OF THE DRAWINGS

FIG. 1 is a drawing that shows a schematic construction of a transaction system in accordance with one embodiment of the present invention.

FIG. 2 is a drawing that shows a schematic hard ware construction of the automatic machine shown in FIG. 1.

FIG. 3 is a drawing that shows a schematic functional construction of the automatic machine shown in FIG. 1.

FIG. 4 is a drawing that shows one example of a state table in accordance with the present embodiment.

FIG. 5 is a drawing that shows an arrangement of a WEB transaction state table (state w) of the present embodiment.

FIG. 6 is a drawing that shows an arrangement of a WEB transaction extension state table (state z) of the present embodiment.

FIG. 7 is a drawing that shows the contents of an extension file of the WEB transaction of the present embodiment.

FIG. 8 is a drawing that shows the sequence of transaction processes of an automatic machine in accordance with the present embodiment.

FIG. 9 is a drawing that shows a display screen in a transaction process of the automatic machine in accordance with the present embodiment.

FIG. 10 is a drawing that shows another display screen in a transaction process of the automatic machine in accordance with the present embodiment.

FIG. 11 is a drawing that shows still another display screen in a transaction process of the automatic machine in accordance with the present embodiment.

FIG. 12 is a drawing that shows still another display screen in a transaction process of the automatic machine in accordance with the present embodiment.

FIG. 13 is a drawing that shows still another display screen in a transaction process of the automatic machine in accordance with the present embodiment.

FIG. 14 is a drawing that shows still another display screen in a transaction process of the automatic machine in accordance with the present embodiment.

FIG. 15 is a drawing that shows still another display screen in a transaction process of the automatic machine in accordance with the present embodiment.

FIG. 16 is a drawing that shows still another display screen in a transaction process of the automatic machine in accordance with the present embodiment.

FIG. 17 is a drawing that explains processes executed by the WEB transaction control section in accordance with the present embodiment.

### DESCRIPTION OF THE PREFERRED EMBODIMENTS

Referring to Figures, the following description will discuss one embodiment of an automatic transaction device and a recording medium which has a transaction program, and is read by a computer, in accordance with the present invention. Here, the present invention is not intended to be limited by this embodiment.

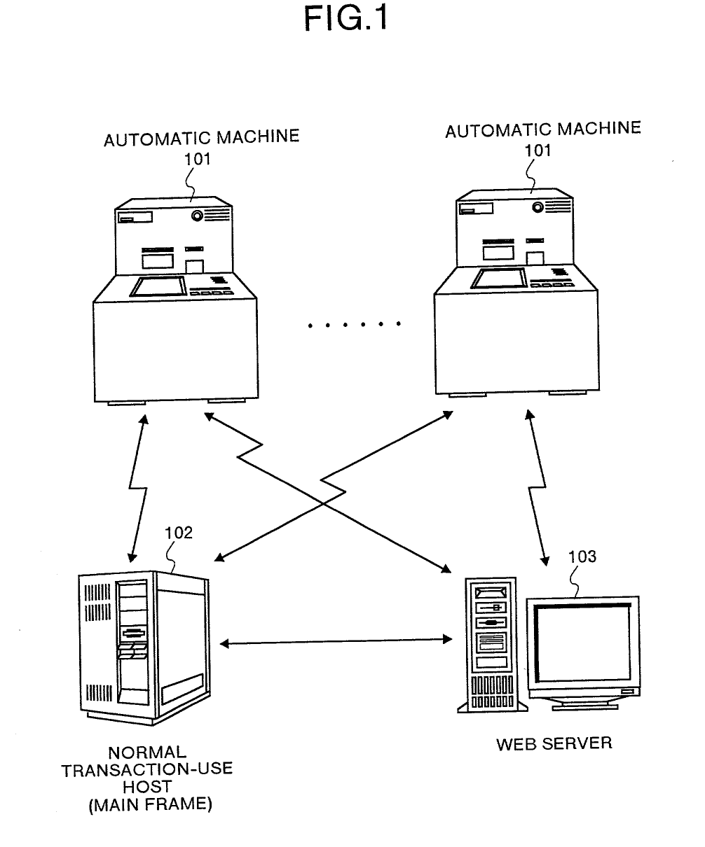

FIG. 1 is a drawing that schematically shows the arrangement of a transaction system in accordance with one embodiment of the present invention. This transaction system is provided with at least one automatic machine 101, a normal transaction-use host (main frame) 102 which holds bank account information, etc. of users (customers), and communicates with the automatic machine 101 through a dedicated line or a public line at the time of a normal transaction, and a WEB server 103 which communicates with the automatic machine 101 through the Internet at the time of a WEB transaction. In addition to the communications with the automatic machine 101 at the time of a normal transaction, the normal transaction-use host 102 also transmits a transaction processing state table (hereinafter, referred to as state table), which will be described later, to the automatic machine 101 so as to make new setting or updating, regularly or in a predetermined cycle.

In addition to communications with the automatic machine 101 at the time of a WEB transaction, the WEB server 103 also transmits a state table to the automatic machine 101 so as to make new setting or updating regularly or in a predetermined cycle. Moreover, the normal transaction-use host 102 and the WEB server 103 communicate with each other at the time of a WEB transaction so as to carry out processes such as confirmation of the balance, transfer processes and settlement of accounts. Here, with respect to the communication between the automatic machine 101 and the WEB server 103, the automatic machine 101 and the WEB server 103 may be connected by LAN (Local Area Network) so that the communication is carried out through the Intranet within the LAN (Local Area Network) without using the Internet, or the automatic machine 101 may be allowed to remote-access the WEB server 103 through a public line.

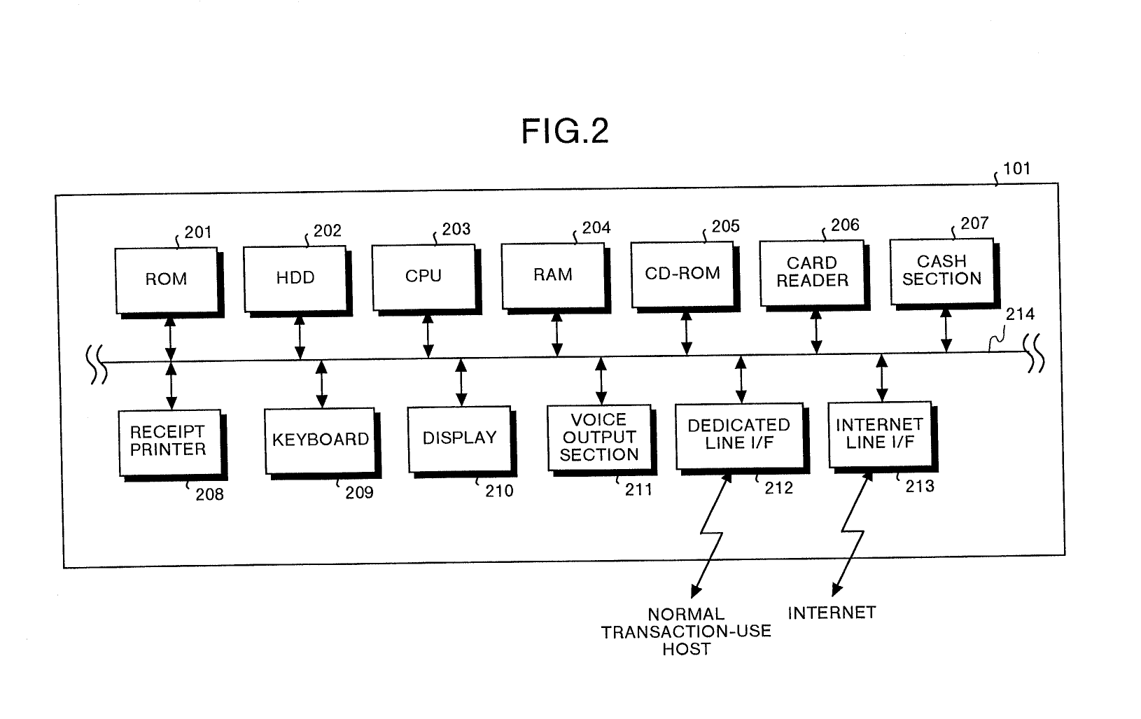

FIG. 2 is a drawing that shows a schematic hardware structure of the automatic machine 101 of FIG. 1. The automatic machine 101 is provided with a ROM (Read Only Memory) 201 for storing a boot program, etc., a controlling program for controlling the respective parts of the automatic machine 101, a hard disk (HDD) 202 for storing the processing states, etc., a CPU (Central Processing Unit) 203 for controlling the respective parts of the automatic machine 101 based upon the program stored in the ROM 201 and HDD 202, a RAM (Random Access Memory) 204 used by the CPU 203 as a work area, a CD-ROM drive 205 for reading programs and data from a CD-ROM, and a card reader 206 for reading data from a card such as a cash card of a bank and a credit card of a credit company.

Moreover, the automatic machine 101 is provided with a cash section 207 for executing cash processes such as receipt of cash and payment of cash, a receipt printer 208 for printing receipts, a display 210 such as a CRT(Cathode Ray Tube) and a LCD (Liquid Crystal Display) for providing a display, a voice output section 211 for outputting voice through a speaker, a dedicated line interface (I/F) 212 for communicating with the normal transaction-use host 102 through the dedicated line, an Internet line I/F 213 for communicating with the WEB server through the Internet and a bus 214 for connecting the respective parts.

The ROM 201 and HDD 202 store programs such as boot programs and control programs. The kinds of the ROM 201 and HDD 202 are not particularly limited, and other recording media may be used in place of the ROM 201 and HDD 202. The CPU 203 controls the respective parts of the automatic machine 101 based upon the programs stored in the ROM 201 and the HDD 202. The RAM 204 is used as a work area, etc. of the CPU 203. The CD-ROM drive 205 is used, for example, at the time of activation of the system, at the time of installing a control program from a CD-ROM to the HDD 202, and other occasions. Instead of the CD-ROM drive 205, other portable recording media, such as a DVD drive, may be used.

The card reader 206 reads information form a card, such as a cash card of a bank or a credit card of a credit company, and transfers the information to the CPU 203. The cash section 207 executes cash processes such as receipt of cash and payment. The receipt printer 208 prints receipts. The keyboard 209 transfers inputs from the user to the CPU 203. The display 210 provides various displays. The voice input section 211 carries out voice outputs. The dedicated line I/F 212 communicates with the normal transaction-use host 102 through the dedicated line.

The Internet line I/F 213 communicates with the WEB server 103 through the Internet. Here, instead of the dedicated line I/F 212, a public line I/F, which communicates with the normal transaction-use host 102 through a public line, may be used. Moreover, the communication may be made with the WEB server 103 by connecting the Internet through the public line I/F. In other words, the communication with the normal transaction-use host 102 and the communication with the WEB server 103 may be made through a physically single communication interface.

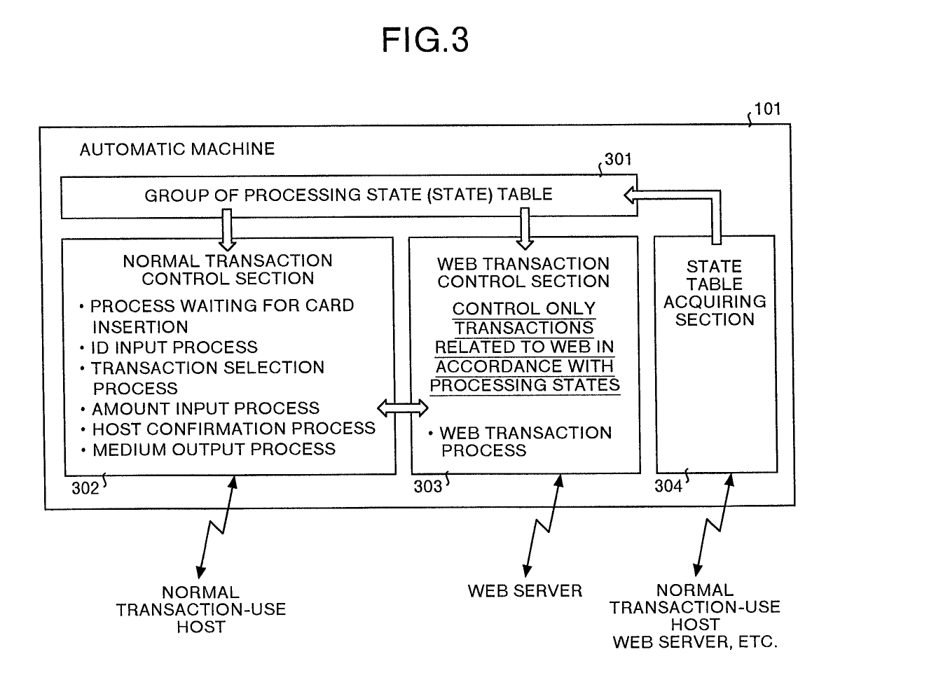

FIG. 3 is a drawing that shows a schematic functional construction of the automatic machine 101 shown in FIG. 1. The automatic machine 101 is provided with a state table group 301 that is a collection of state tables, a normal transaction control section 302 which controls normal transactions that occupy most of the functions of the automatic machine 101 based upon states of the normal transaction-use state table (normal transaction-use state table) contained in the state table group 301, a WEB transaction control section 303 which is placed in a separated manner from the normal transaction control section 302, and only controls transactions related to the WEB based upon states of the WEB transaction-use state table (WEB transaction-use state table), and a state table acquiring section 304 which acquires a state table from the normal transaction-use host 102, the WEB server 103 or another device on the network through the communication line so as to set, supplement, or update the state table of the state table group 301.

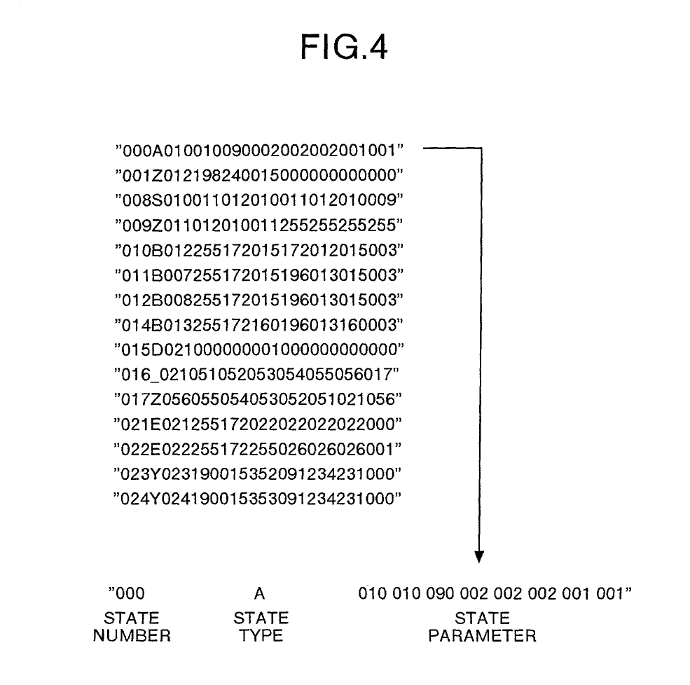

The state table group 301 is stored in a recording medium such as the HDD 202 shown in FIG. 2, and any of the state tables contained in the state table group 301 is read out by the normal transaction control section 302 and the WEB transaction control section 303, if necessary, and set, added or updated by the state table acquiring section 304. FIG. 4 shows one example of the state table in accordance with the present embodiment. This state table, which is a definition body classified into types based upon the respective functions, includes a state A of type (state type) A for executing a waiting process for a card insertion, state B of type (state type) B for executing an inputting process of an ID number, etc.

Moreover, unique numbers (state numbers) are respectively assigned to the state tables. Each state table has 8 parameters (state parameter). Then, processing states such as a screen number, a state number of a state table after normal completion, a state number of a state table after time-out, and a state number at the time of canceling are written in these 8 state parameters. The contents of the states in these 8 parameters are different depending on the state types.

Moreover, these state tables are divided into normal transaction-use state tables and WEB transaction-use state tables. With respect to the normal transaction-use state tables, examples thereof include a state A for executing a waiting process for a card insertion, state B for executing an inputting process of an ID number, etc., and with respect to the WEB transaction-use state tables, examples thereof include a state w, etc. This state w includes states for allowing the automatic machine 101 to access a URL. The automatic machine 101 provides some means for allowing the WEB server 103 to control the devices of the automatic machine 101. One of them provides a definition for completing the state w and for determining the next state. Here, in addition to the state w, for example, a WEB transaction-use state table used for accessing another URL sight may be prepared, and a plurality of WEB transaction-use state tables may be used.

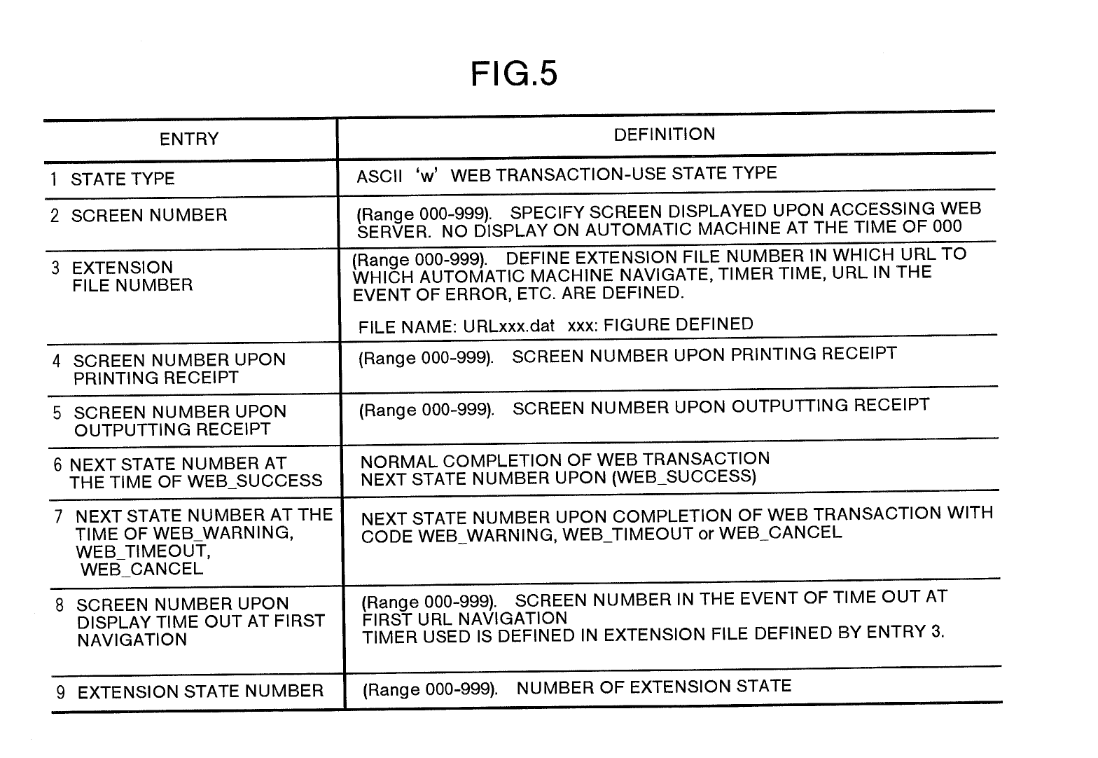

FIG. 5 is a drawing that shows an arrangement of the WEB transaction state table (state w) in accordance with the present embodiment. The state w includes a definition of the state type (entry 1), and states of 8 parameters consisting of: “screen number” (entry 2), “extension file number” (entry 3), “screen number upon printing receipt” (entry 4), “screen number upon outputting receipt” (entry 5), “next state number at the time of WEB SUCCESS” (entry 6), “next state number at the time of WEB_WARNNING, WEB_TIME-OUT, or WEB_CANCEL” (entry 7), “screen number in the event of display time-out at the first navigation” (entry 8) and “extension state number” (entry 9).

The state type of the state w is “w”, and is defined by “w” in the ASCII (American Standard Code for Information Interchange). The “screen number” of entry 2 is to specify the screen displayed while accessing the WEB server 103, and is defined by a numeric value from 000 to 999. In the case when 000 is specified, the automatic machine 101 does not display anything. The “extension file number” of entry 3 is an extension file number by which URLs to which the automatic machine 101 navigates, URLs to which it navigates at the time of time-our or error, etc. are defined, and is defined by a numeric value from 000 to 999. The file name of the extension file starts with “URL”, and to this is added the extension file number, and then is further added “. dat”.

The “screen number upon printing a receipt” is the number of a screen displayed upon printing a receipt, and is defined by a numeric value from 000 to 999. The “screen number upon outputting a receipt” is the number of a screen displayed upon outputting a receipt, and is defined by a numeric value from 000 to 999. The “next state number at the time of WEB_SUCCESS” of entry 6 is the state number of the next state table upon normal completion of a WEB transaction (upon completion with a code “WEB_SUCCESS”.

The “next state number at the time of WEB_WARNNING, WEB_TIME-OUT, or WEB_CANCEL” of entry 7 is the state number of the next state table upon completion with a code “WEB_WARNNING”, a code “WEB_TIME-OUT” or a code “WEB_CANCEL”. The “screen number in the event of display time-out at the first navigation” of entry 8 is the number of a screen displayed in the event of time-out during the first URL navigation, and is defined by a numeric value from 000 to 999. The timer used in this case is defined in the extension file defined in entry 3. The “extension state number” of entry 9 is the number of an extension-use state table (extension state table), and is defined by a numeric value from 000 to 999.

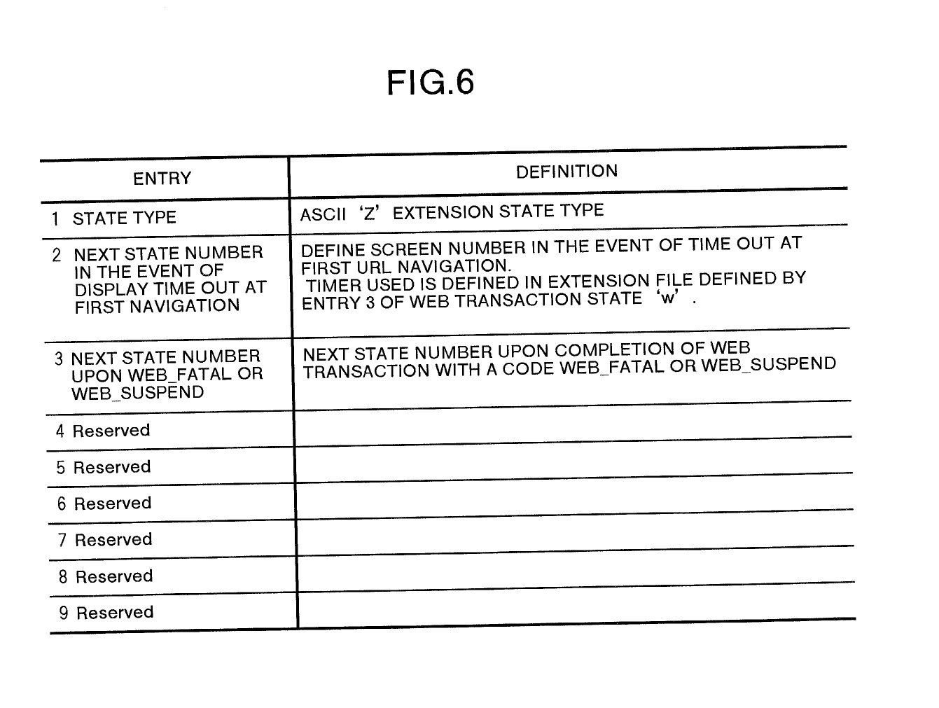

FIG. 6 is a drawing that shows an arrangement of the WEB transaction extension state table (state z) in accordance with the present embodiment. The state z includes a definition of the state type (entry 1), and states of 8 parameters consisting of: “next state number in the event of display time-out at the first navigation” (entry 2), “next state number at the time of WEB_FATAL or WEB_SUSPENDED” (entry 3), and 6 “Reserved” (entry 4 to entry 9). The state type of the state z is “z”, and is defined by “z” in the ASCII (American Standard Code for Information Interchange).

The “next state in the event of display time-out at the first navigation” of entry 2 is the state number of the next state table in the event of time-out during the first URL navigation, and the timer used in this case is defined in the extension file defined in entry 3 of state w. The “next state number at the time of WEB_FATAL or WEB_SUSPENDED” of entry 3 is the state number of the next state table upon completion of a WEB transaction with a code of WEB_FATAL or a code of WEB_SUSPENDED. Each of the “Reserved” of entry 4 to entry 9 is a reserved area.

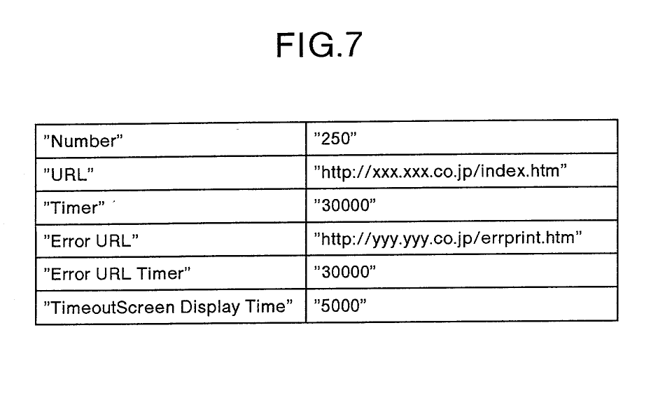

FIG. 7 is a drawing that shows the contents of a WEB transaction extension file in accordance with the present embodiment. This extension file includes a definition (for example, 250) of the number of the extension file, a definition of a URL to which the first navigation is made, a definition of a timer (for example, 30000 seconds) up to the time out of the first navigation, a definition of a URL to which a navigation is made in the event of an error, a definition of a timer (for example, 30000 seconds) up to the time out of the URL navigation in the event of an error and a definition of display time for a display (for example, 5000 seconds) upon detection of the time out of the first URL navigation. Here, the contents of the states in the above-mentioned state w, state z and extension file are not particularly limited, and may be changed, if necessary.

As shown in the foregoing FIG. 3, based upon the states of the aforementioned normal transaction-use state table, the normal transaction control section 302 communicates with the normal transaction-use host 102 through the dedicated line-use I/F 212 shown in FIG. 2, and controls the respective parts of the automatic machine 101 such as the card reader 206 and the display 210, thereby executing normal transactions that occupy most of the functions of the automatic machine 101. On the other hand, based upon the states of the WEB transaction-use state table (w state), the WEB transaction control section 303 communicates with the WEB server 103 through the Internet line-use I/F 213 shown in FIG. 2, and controls the respective parts of the automatic machine 101 such as the card reader 206 and the display 210, thereby executing only the transactions related to the WEB.

Here, the WEB transaction control section 303 may read user information, such as a card number and bank balance, acquired by the normal transaction control section 302 during normal transactions, from the recording medium such as the RAM 203, and transmit the information to the WEB server 103. With respect to the card number, since the normal transaction control section 302 has preliminarily read it through the card reader 206, the user need not input it through the keyboard 209. The WEB server 103 selects users based upon the user information so that it can provide services suitable for the respective users. The state table acquiring section 304 of the automatic machine 101 acquires state tables from the normal transaction-use host 102, the WEB server 103 or another device through communication lines so that the state tables in the group of state tables 301 are set, supplemented or updated.

Here, the above-mentioned description has discussed the functional construction of the automatic machine 101; however, the respective constituent elements of the automatic machine 101 shown in FIG. 3 have been conceptually described based upon their functions, and are not necessarily arranged physically as illustrated in FIG. 3. For example, all or one portion of the processing functions possessed by the automatic machine 101 may be realized by the CPU 203 and programs interpreted and executed by the CPU 203. In other words, computer programs, which give instructions to the CPU 203 in cooperation with the OS (Operation System), etc., and allows the CPU 203 to execute various processes, are stored in the ROM 201 and HDD 202. Then, the CPU 203 executes various processes in accordance with these programs. Moreover, all or one portion of the processing functions possessed by the automatic machine 101 may be realized by hardware using wired logic.

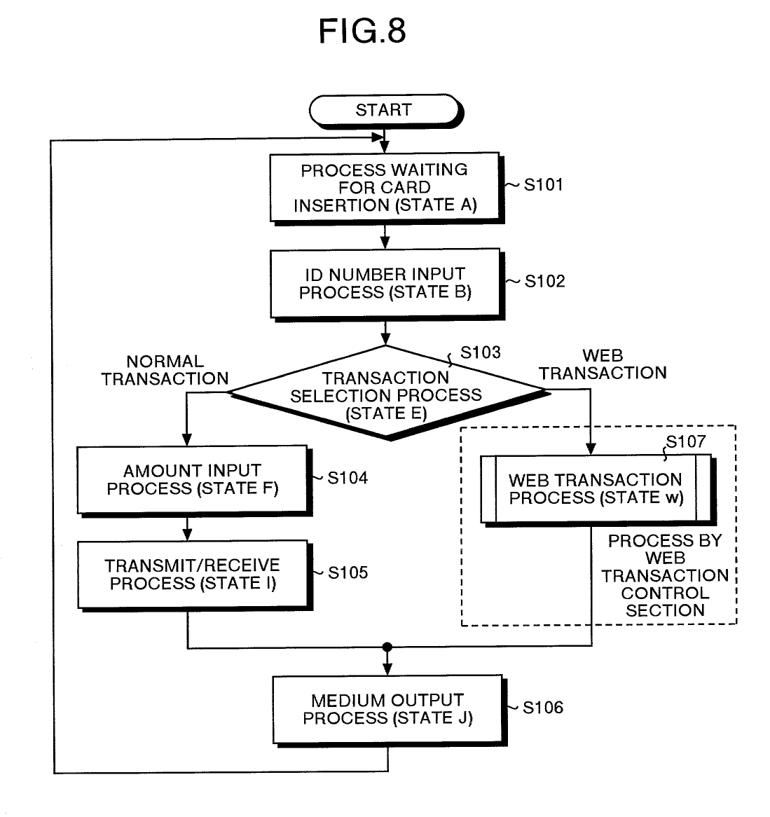

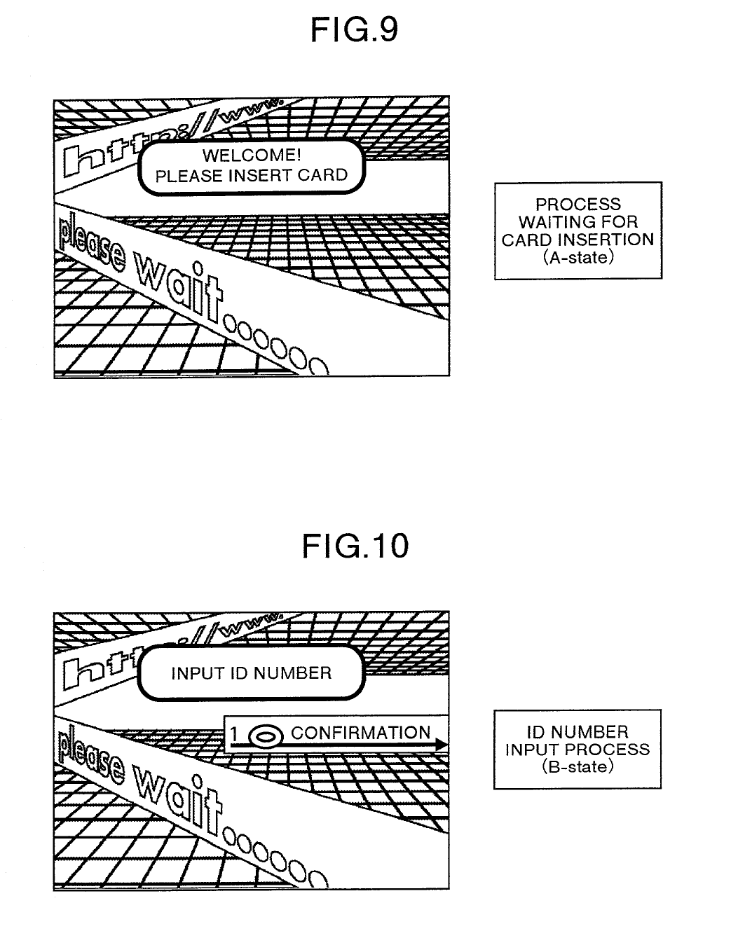

In the above-mentioned construction, referring to Figures, an explanation will be given of the operation of the present embodiment. FIG. 8 is a flow chart showing the sequence of transaction processes of an automatic machine 101 in accordance with the present embodiment. In the transaction processes, first, the normal transaction control section 302 executes a controlling operation so that a screen as shown FIG. 9 is displayed based upon state A, thereby waiting for a card insertion into the automatic machine 101 (S101). Upon insertion of a card, a screen as shown in FIG. 10 is displayed based upon state B, and an ID number from the user is inputted (S102).

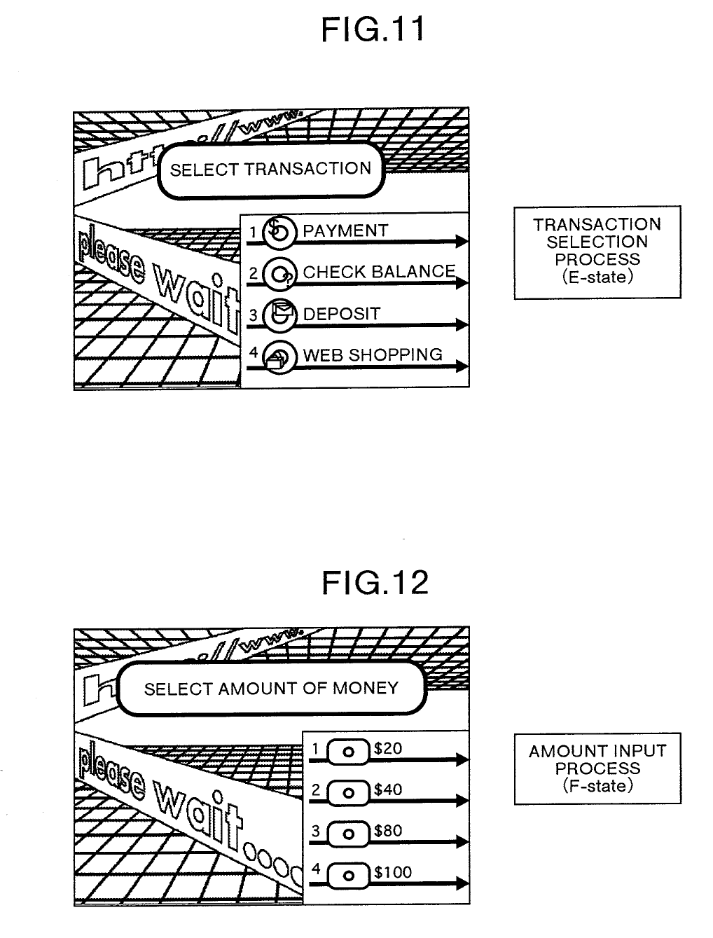

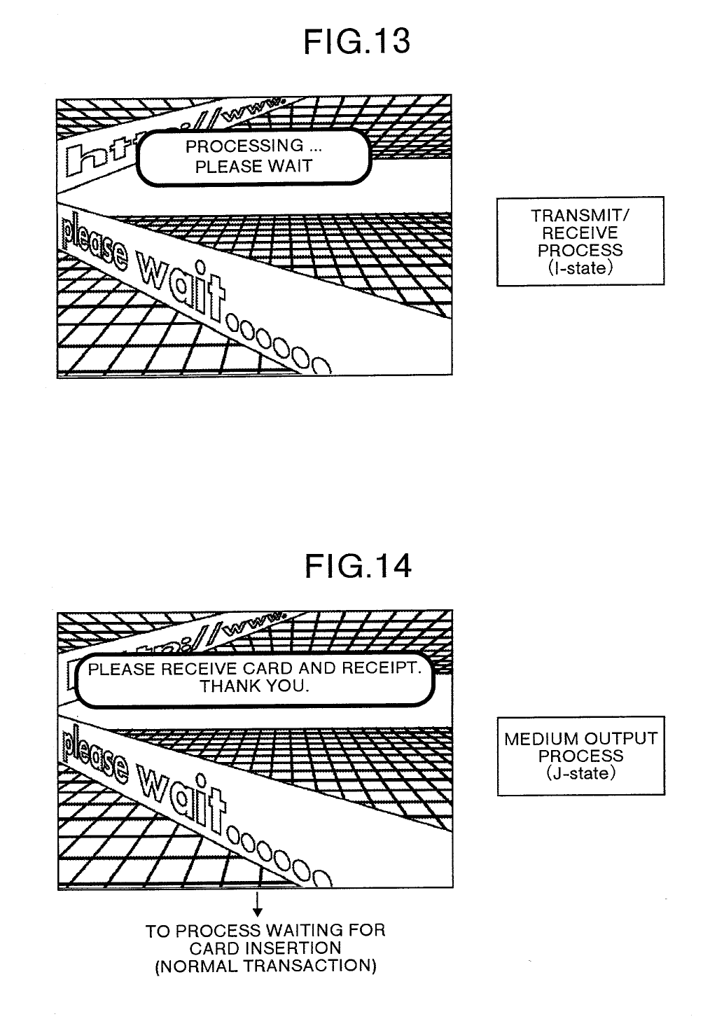

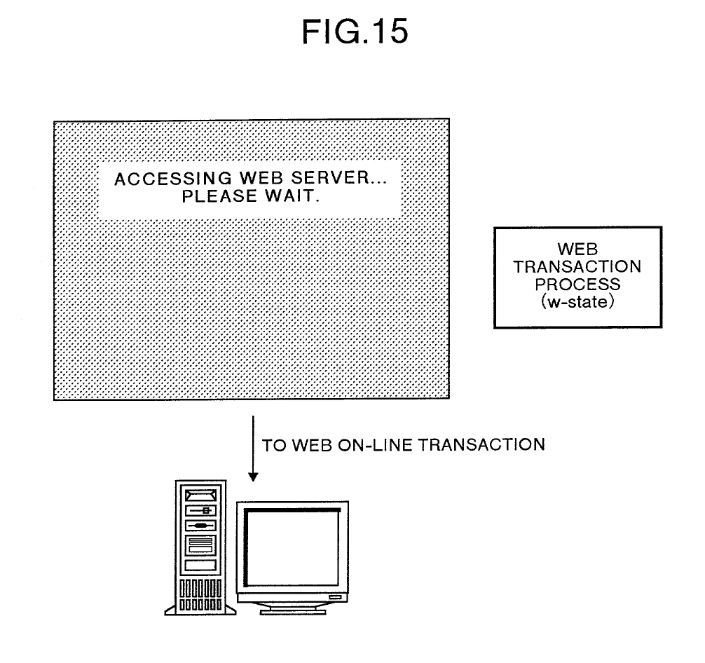

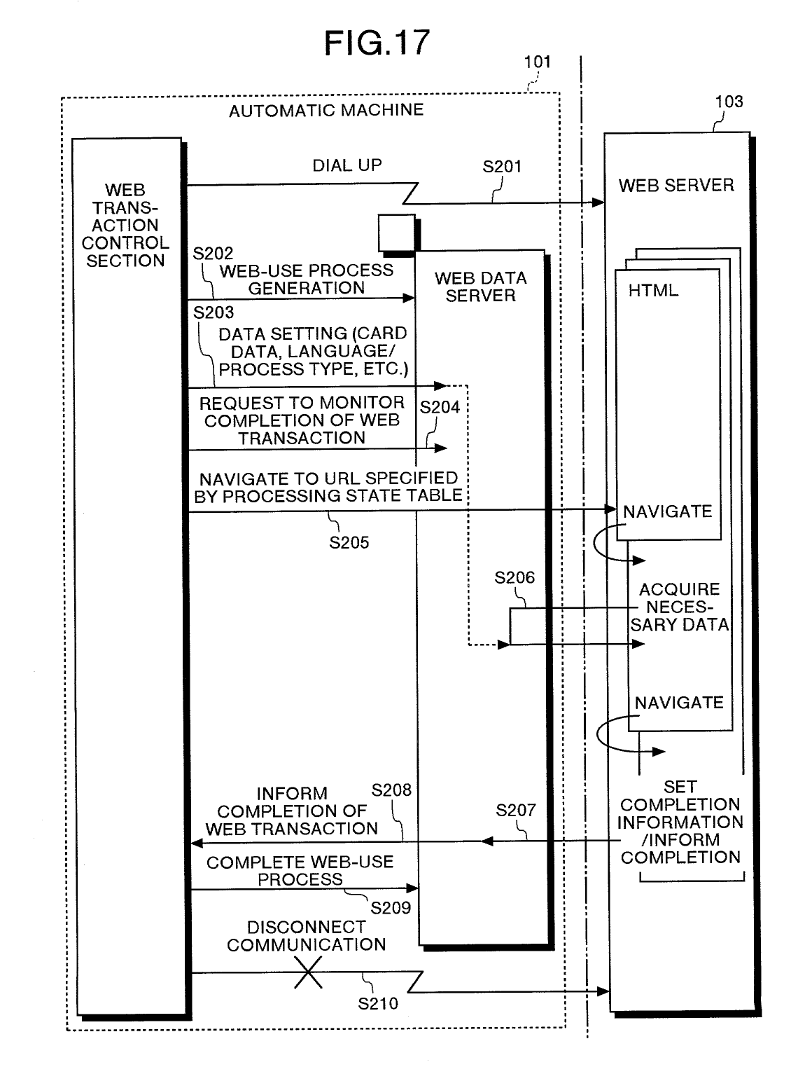

After an ID number has been inputted, a screen used for selection of transactions as shown in FIG. 11 is displayed, thereby waiting for an input from the user for selection (S103). In this transaction selection-use screen, selection menus including normal transactions, such as payment, checking of the balance and money received, and the WEB transactions, such as WEB shopping, are displayed. Here, supposing that “payment” is selected, the normal transaction control section 302 successively carries out controlling processes so that, based upon state F, a screen as shown in FIG. 12 is displayed, thereby allowing the user to input the amount of payment (S104) Next, based upon state I, a screen as shown in FIG. 13 is displayed, thereby communicating with the normal transaction-use host 102 so as to carry out a confirmation process (S105). Lastly, based upon state J, the card and a receipt are outputted, thereby returning to step S101 (S106) Here, supposing that the WEB transaction process is selected as step S103, the WEB transaction control section 303 starts to carry out controlling processes in place of the normal transaction control section 302 so that, based upon state w, a screen as shown in FIG. 15 is displayed, thereby starting the WEB transaction (S107). FIG. 17 is a drawing that explains the processes executed by the WEB transaction control section 303 in accordance with the present embodiment. The WEB transaction control section 303 first connects to the WEB server 103 through a dial-up process (S201), thereby generating a WEB-use process (WEB data server) (S202).

Then, the card data (card number, etc.), language (language selected in the case when multi-languages are selectable), type of process (WEB shopping, issuance of movie free tickets, etc.), etc. that the normal transaction control section 302 has acquired are set in this WEB data server (S203) In this case, the user information such as bank balance information, acquired by the normal transaction control section 302 from the normal transaction-use host 102, may be set therein. Thus, the WEB server 103 can obtain detailed user information from the automatic machine 101 so that it is possible to provide detailed processes suitable for the respective users.

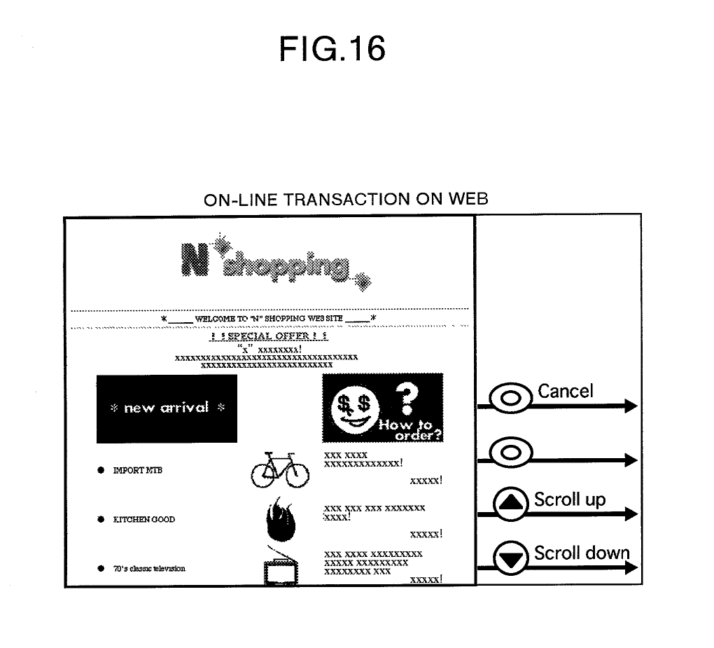

Next, the WEB transaction control section 303 requests the WEB data server to monitor the completion of the WEB transaction (S204), and makes a navigation to the URL specified by state w (specified by the extension file) (S205). Then, a WEB page as shown in FIG. 16 is displayed on the automatic machine 101 by files written in HTML (Hyper Text Markup Language), etc. of the URL sight, and necessary data is acquired from the WEB data server (S206); thus, the WEB transaction is executed.

In this WEB transaction, shopping, issuance of movie free tickets, etc. using the WWW are available. Moreover, a customer screen using motion pictures and natural scenery pictures can be realized. The maintenance for this customer screen can be carried out by the WEB server 103. Here, the WEB server 103 communicates with the normal transaction-use host 102 so as to call for additional communications required for the WEB transaction, or communicates with a business connection so as to give orders. Alternatively, it makes a judgment as to whether or not a ticket is available, or acquires an issue log of a ticket.

In this WEB transaction, ActiveX is used so as to operate devices peculiar to the automatic machine 101 (such as the card reader 206 and the sheet printer 208). This ActiveX is called for from JavaScript or VBScript within the HTLM. When the user request for the completion or suspension of the WEB transaction, the WEB transaction control section 303 is informed of the completion of the WEB transaction (S207, S208); thus, the WEB transaction control section completes the WEB-use process. Then, the normal transaction control section 302 again starts controlling processes so that the sequence proceeds to step S106 of FIG. 8.

As described above, in the present embodiment, the normal transaction control section 302 controls normal transactions based upon a processing state table (A state, etc.) used for normal transactions, while the WEB transaction control section 303, installed separately from the normal transaction control section 302, controls the WEB transaction based upon a processing state table (w state) used for WEB transactions; therefore, it is possible to execute not only normal transactions, but also the WEB transaction which deals with new trading while updating information on demand, without causing any adverse effect on the control of the normal transactions.

Moreover, since the transaction is controlled by using state tables, the interface between the automatic machine 101 and the normal transaction-use host 102, as well as the interface between the automatic machine 101 and the WEB server 103, is unified so that it becomes easier to add automatic machines of other types and other makers. In other words, the interface related to the WEB transaction of the automatic machine 101 is standardized, thereby making it possible to accelerate the WEB transaction on the automatic machine 101, and also to expand the application of the automatic machine 101 as an information terminal. Moreover, since the controls and operations related to the WEB transaction can be boxed up, the WEB transaction is expanded while reducing its influences on the normal transactions. In other words, it is possible to provide new services using the WEB, while maintaining inherent functions of the automatic machine.

Moreover, extension state tables, which can be user-customized, are downloaded regularly, or downloaded in response to a sudden event so that it becomes possible to readily meet the user's demands, and consequently to further expand the functions of the automatic machine 101 as an information terminal. Furthermore, information to be given to the automatic machine 101 can be updated on a real time basis so that the user can be informed of necessary information and encouraged to operate the system. It is also possible to properly deal with alternation of the location of the WEB server and alternation of the contents made by information/commodity providers.

In other words, the WEB transaction control section 303 is incorporated into a conventional automatic machine so as to add extension w state to the group of state tables; thus, the addition of the WEB transaction function is easily realized, thereby making it possible to accelerate and expand the services of the automatic machine 101 using the Internet. Moreover, since electronic trading is executed by the automatic machine 101 capable of storing public data, it becomes possible to improve the reliability of electronic trading. Here, printing certifying each transaction may be given on the rear face of the receipt by using the receipt printer 208 in the automatic machine 101.

In addition, a computer program which realizes the transaction method in accordance with the present embodiment may be stored in portable recording media including magnetic disks such as floppy disks, semiconductor memories such as ROMs, EPROMs, EEPROMs and flash ROMs (including those built in cartridges, PC cards, etc.), optical disks such as CD-ROMs and DVDs and magneto-optical disks such as MOs, and the program recorded in these media may be installed in fixed media including ROMs, RAMs, hard disks, etc. that are built in the automatic machines so as to provide the above-mentioned transaction functions to the automatic machines.

Moreover, this program may be transferred through a network, such as LAN, WAN, the Internet, etc. so that the transferred program is installed in a fixed recording medium in an automatic machine. Furthermore, the program is not limited to those singly formed, and may include those constituted in a dispersed manner as a plurality of modules and libraries and those which can achieve their function in cooperation with another program such as an OS.

As described above, in accordance with the present invention, the WEB transaction process means (WEB transaction control section 303) controls the WEB transaction based upon at least one WEB transaction-use processing state table (w state); therefore, it is possible to execute not only normal transactions, but also the WEB transaction which deals with new trading while updating information on demand, without causing any adverse effect on the control of the normal transactions.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimd is:

1. An automatic transaction device, which carries out a normal transaction process with a predetermined host based upon a processing state table when a normal transaction operation is specified, comprising:
a WEB transaction-use processing state table which stipulates WEB transaction carried out by the WWW; and
WEB transaction processing unit which executes a WEB transaction process with a predetermined WEB server based upon the WEB transaction-use processing state table when the WEB transaction is selected.

2. The automatic transaction device according to claim 1, wherein the WEB transaction processing means transmits information obtained in the normal transaction to the WEB server to which the accessing is made.

3. The automatic transaction device according to claim 1, further comprising:
acquiring means for acquiring the WEB transaction-use processing state table through a communication line.

4. The automatic transaction device according to claim 1, wherein the WEB transaction-use state table includes a definition of an extension file in which on e portion of the definition for the WEB transaction is written.

5. The automatic transaction device according to claim 4, wherein the WEB transaction processing means transmits information obtained in the normal transaction to the WEB server to which the accessing is made.

6. The automatic transaction device according to claim 4, further comprising:
acquiring means for acquiring the WEB transaction-use processing state table through a communication line.

7. The automatic transaction device according to claim 1, wherein the WEB transaction-use processing state table include a definition of a screen displayed upon access to a WEB server, a definition of an extension file, a definition of a screen upon printing a receipt, a definition of a screen upon outputting the receipt, a definition of the next processing state table upon completion of a normal WEB transaction, a definition of the next processing state table upon completion of a WEB transaction with a predetermined code, a definition of a screen in the event of time out during the first URL navigation and a definition of an extension processing state table, said extension processing state table being allowed to include the state of a screen in the event of time-out during the first URL navigation and the state of the next processing state table upon completion of a WEB transaction with a predetermined code, said extension file being allowed to include a definition of URL to which the first navigation is made, a definition of a timer determining time-out of the first URL navigation, a definition of URL to which a navigation is made in the event of an error, a definition of a timer determining time-out of the URL navigation made in the event of an error, and a definition of display time of a display used upon detection of the time-out of the first URL navigation.

8. The automatic transaction device according to claim 7, wherein the WEB transaction processing means transmits information obtained in the normal transaction to the WEB server to which the accessing is made.

9. The automatic transaction device according to claim 7, further comprising:
acquiring means for acquiring the WEB transaction-use processing state table through a communication line.

10. A recording medium, which has a transaction program for allowing a computer to execute various transaction methods, and is read by a computer, comprising:
a transaction program for allowing the computer to execute WEB transaction processing operation with the predetermined server based upon the WEB transaction-use processing state table when a WEB transaction is selected.
